(19) United States
(12) Patent Application Publication
(10) Pub. No.: US 2012/0065853 A1
(43) Pub. Date: Mar. 15, 2012

(54) SYSTEM AND METHOD TO PREVENT SHIFT HUNTING

(75) Inventors: Jason Stoller, Morton, IL (US); Adam J. Vaccari, Peoria, IL (US); Michael D. Beyer, Chillicothe, IL (US); Christopher A. Rhoades, Metamora, IL (US)

(73) Assignee: Caterpillar Inc., Peoria, IL (US)

(21) Appl. No.: 12/879,647

(22) Filed: Sep. 10, 2010

(51) Int. Cl. F16H 61/10

(52) U.S. Cl. 701/58

(57) ABSTRACT

A method for preventing shift hunting in a powertrain is disclosed. The powertrain includes an engine and a transmission having a variator, a first gearset, and a second gearset. The engine is operated at a first substantially constant speed. A first transmission shift condition is detected. A desired transmission output torque is determined. The transmission is operated at a transmission torque different than the desired torque as a function of the first shift condition.

### TECHNICAL FIELD

The present disclosure relates generally to continuously variable transmissions. Specifically, the present invention relates to the shifting of continuously variable transmissions.

### BACKGROUND

When a vehicle or machine including a transmission is operated in a band around a shift point of the transmission, the transmission may experience shift hunting which can result in increased fuel consumption, operator discomfort or irritation, and transmission wear or damage. Delaying a shift point may alleviate the shift hunting condition, but may cause asynchronous shifts. When a drivetrain includes flexible or fluid couplings, such as a torque converter, these couplings may absorb the shocks from asynchronous shifts. However, in a drivetrain without a flexible or fluid coupling, forces and shocks to the driveline resulting from asynchronous shifts may cause damage, wear, and component failures. Jerking from the asynchronous shifts may cause operator discomfort or irritation.

U.S. Pat. No. 6,663,534 discloses a method for preventing oscillating gearshifts of a motor vehicle automatic transmission with an electronic transmission control device. The control device monitors the current road resistance from a comparison of measured vehicle acceleration with a theoretical vehicle acceleration and determines therefrom the value of differential acceleration. The engine torque is reduced if: (a) the position of the accelerator pedal of the motor vehicle is greater than a first limit value; (b) the differential acceleration is greater than a second limit value; (c) the measured vehicle acceleration is greater than a positive third limit value; (d) the theoretical impingement in the next higher gear is lower than a fourth limit value; and (e) the current engine speed is greater than a fifth limit value.

### SUMMARY OF THE INVENTION

In one aspect, a method for preventing shift hunting in a powertrain is disclosed. The powertrain includes an engine and a transmission having a variator, a first gearset, and a second gearset. The engine is operated at a first substantially constant speed. A first transmission shift condition is detected. A desired transmission output torque is determined. The transmission is operated at a transmission torque different than the desired torque as a function of the first shift condition.

In another aspect, a system for preventing shift hunting is disclosed. The system includes a powertrain and a controller. The powertrain includes an engine and a transmission operably connected to the engine. The transmission includes a variator, a first gearset, and a second gearset. The controller is configured to operate the engine at a first substantially constant speed, detect a first transmission shift condition, determine a desired transmission output torque, and operate the transmission at a transmission output torque different than the desired transmission output torque as a function of detecting the first shift condition.

### BRIEF DESCRIPTION OF THE DRAWINGS

FIG. 1 depicts a schematic view of an exemplary embodiment of a system to prevent shift hunting in a powertrain.

FIG. 2 depicts a flowchart of an exemplary method to prevent shift hunting in a powertrain.

FIG. 3 depicts an exemplary graph of a relationship between a motor ratio and a transmission ratio.

FIG. 4 depicts a schematic view of an exemplary embodiment of a state machine.

FIG. 5 depicts another exemplary graph of a relationship between a motor ratio and a transmission ratio.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

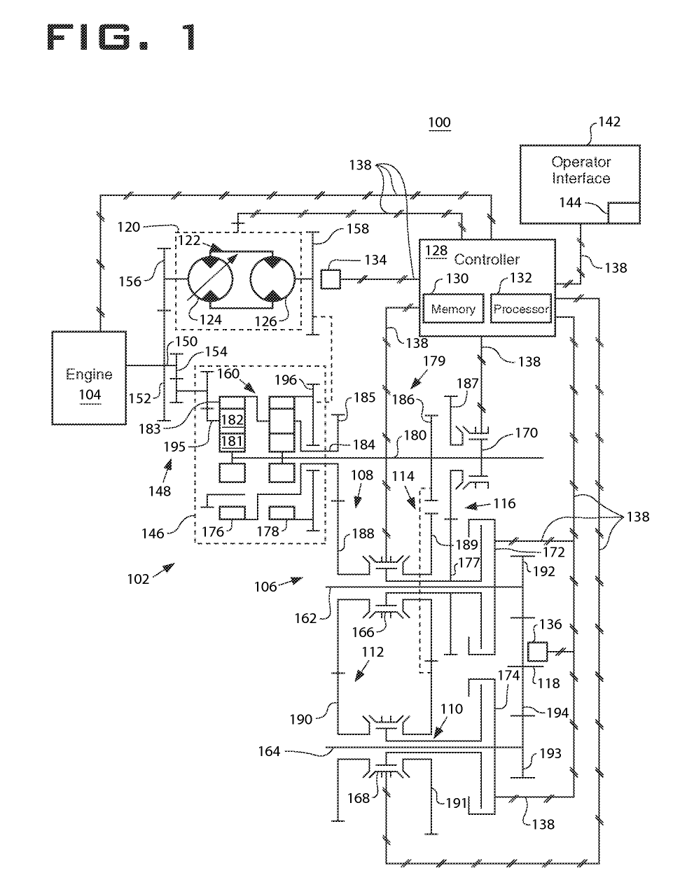

FIG. 1 illustrates a schematic view of a system to prevent shift hunting 100. The system includes a powertrain 102, a controller 128, and an operator interface 142. The system 100 may be included in a vehicle (not shown) to provide power and/or motor force to move the vehicle in a direction. In another embodiment, the system 100 may be included in a stationary machine to provide power, for example, in a manufacturing environment.

The powertrain 102 may include any group of components that generate and deliver power to a vehicle to move the vehicle and/or allow the vehicle or machine to do work as is known by an ordinary person skilled in the art now or in the future. The powertrain 102 may deliver power to one or more drive axle, wheel, track, propeller, or any other device that will move the vehicle in a direction. The powertrain 102 may also deliver power to a system that allows the vehicle to do work. In another embodiment, the powertrain 102 may deliver power to a stationary machine.

The powertrain 102 includes an engine 104 and a transmission 106. For purposes of this application the engine 104 may include any machine that converts energy into mechanical force or motion as would be known by an ordinary person skilled in the art now or in the future; and is capable of powering the transmission 106 as described herein. In the depicted embodiment the engine 104 converts energy into rotational force and/or motion through rotating transmission input member 150. In one embodiment the engine 104 is an internal combustion piston engine configured to provide rotational force at a rotational velocity within a narrow range.

For purposes of this application the transmission 106 may include one or more of a mechanical transmission, any variator, gearing, belts, pulleys, discs, chains, pumps, motors, clutches, brakes, torque converters, fluid couplings and any transmission that would be known by an ordinary person skilled in the art now or in the future. In the depicted embodiment, the transmission 106 includes a variator 120, an adder 146, mechanical gearing 148, a first gearset 108, a second gearset 110, a third gearset 112, a fourth gearset 114, a fifth gearset 116, and a transmission output 118.

For purposes of this application the variator 120 is a transmission device which can change its' gear ratio continuously as would be known by an ordinary person skilled in the art now or in the future. Examples of variators 120 include belt driven CVTs, toroidal CVTs, hydrostatic transmissions 122, and electric generator and motor combinations.

In the depicted embodiment, the variator 120 includes a hydrostatic transmission 122 (or hystat 122). The hystat 122 includes a variable displacement pump 124 and a hydraulic motor 126. In an alternative embodiment the variator 120 may include an electric power generator and an electric motor (not shown).

In the depicted embodiment, the engine 104 outputs rotational energy and force to the transmission 106 through input member 150. Input member 150 transmits power to the variator 120 through first fixed input gear 152 and variator input gear 156. The term “fixed” may be understood as being integral with, permanently attached, interconnected through a splined connection, or fused by welding, for example, or by any other means that would be known to an ordinary person skilled in the art now or in the future.

The mechanical gearing 148 may include any shafts, gears, and/or other mechanical devices which transmit power from engine 104 to adder 146 as would be known by an ordinary person skilled in the art now or in the future. In the depicted embodiment, the mechanical gearing 148 includes a second fixed input gear 154 and first planetary input gear 195. The input member 150 transmits power through a second power path to mechanical gearing 148 through second fixed input gear 154 and first planetary input gear 195.

The adder 146 combines two power path outputs, one from the variator 120 and the other from the mechanical gearing 148, to selectively transmit power to one of the first gearset 108, the second gearset 110, the third gearset 112, the fourth gearset 114, or the fifth gearset 116. The adder 146 may include any device or set of devices that is/are operable to combine multiple power paths and selectively provide the combined power to a gearset 108, 110, 112, 114, 116 that would be known to an ordinary person skilled in the art now or in the future.

In the depicted embodiment, the adder 146 includes planetary arrangement 160. Planetary arrangement 160 includes first and second planetary gearsets 176 and 178, and a planetary output shaft 179. Each planetary gearset 176 and 178 includes a sun gear 181, a carrier 182, and a ring gear 183, as is customary. The planetary output shaft 179 includes an internal shaft 180 and a sleeve 184, such as a hollow member or hub, which is supported by the internal shaft 180.

The internal shaft 180 connects to the sun gears 181 of the first and second planetary gear sets 176 and 178. The sleeve 184 outputs from the carrier 182 of the second planetary gear set 178 through a first planetary output gear 185. The internal shaft 180 outputs from the sun gears 181 of the first and second planetary gear sets 176 and 178 through a second planetary output gear 186 and through an auxiliary drive gear 187. The first and second planetary output gears 185 and 186 are fixed to the planetary output shaft 179, while the auxiliary drive gear 187 rotates thereon.

The transmission 106 depicted includes a first synchronizer 166, a second synchronizer 168, and a third synchronizer 170. The first and second synchronizers 166 and 168 are three-position synchronizers adapted to move from a neutral position to either of two positions, dependent on a preferred speed and direction. The third synchronizer 170 is fixed to the internal shaft 180 of the planetary output shaft 179, permanently, or through a coupling such as a spline, and moves from a neutral position to an engaged position.

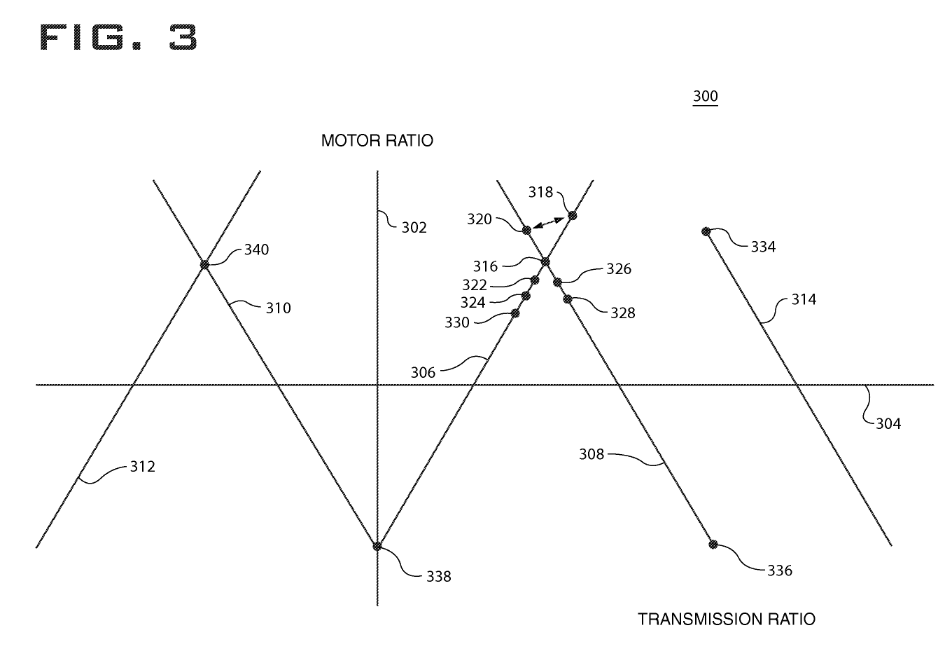

The first gearset 108 includes the first planetary output gear 185, a first low speed reduction gear 188, a first output member 162, the first synchronizer 166, a first clutch assembly 172, and a first output shaft gear 192. When the first gearset 108 drives the transmission output 118, the transmission 106 may be in a low forward gear 306 (described in relation to FIG. 3) to drive the vehicle or machine. When the first gearset 108 is driving the transmission output 118, the first planetary output gear 185 engages the first low speed reduction gear 188. The first synchronizer 166 and the first clutch assembly 172 are controlled by the controller 128 to allow the first low speed reduction gear 188 to drive the first output member 162, the first output member 162 to drive the first output shaft gear 192, and the first output shaft gear 192 to drive a final drive gear 194 which drives the transmission output 118 as would be known by an ordinary person skilled in the art now or in the future.

The second gearset 110 includes the second planetary output gear 186, a second high speed reduction gear 191, a second output member 164, the second synchronizer 168, a second clutch assembly 174, and a second output shaft gear 193. When the second gearset 110 drives the transmission output 118, the transmission 106 may be in a high forward gear 308 (described in relation to FIG. 3) to drive the vehicle or machine. When the second gearset 110 is driving the transmission output 118, the second planetary output gear 186 engages the second high speed reduction gear 191. The second synchronizer 168 and the second clutch assembly 174 are controlled by the controller 128 to allow the second high speed reduction gear 191 to drive the second output member 164, the second output member 164 to drive the second output shaft gear 193, and the second output shaft gear 193 to drive the final drive gear 194 which drives the transmission output 118 as would be known by an ordinary person skilled in the art now or in the future.

The third gearset 112 includes the first planetary output gear 185, a second low speed reduction gear 190, the second output member 164, the second synchronizer 168, the second clutch assembly 174, and the second output shaft gear 193. When the third gearset 112 drives the transmission output 118, the transmission 106 may be in a low reverse gear 310 (described in relation to FIG. 3) to drive the vehicle or machine. When the third gearset 112 is driving the transmission output 118, the first planetary output gear 185 engages the second low speed reduction gear 190. The second synchronizer 168 and the second clutch assembly 174 are controlled by the controller 128 to allow the second low speed reduction gear 190 to drive the second output member 164, the second output member 164 to drive the second output shaft gear 193, and the second output shaft gear 193 to drive the final drive gear 194 which drives the transmission output 118 as would be known by an ordinary person skilled in the art now or in the future.

The fourth gearset 114 includes the second planetary output gear 186, a second high speed reduction gear 189, the first output member 162, the first synchronizer 166, the first clutch assembly 172, and the first output shaft gear 192. When the fourth gearset 114 drives the transmission output 118, the transmission 106 may be in a high reverse gear 312 (described in relation to FIG. 3) to drive the vehicle or machine. When the fourth gearset 114 is driving the transmission output 118, the second planetary output gear 186 engages the first high speed reduction gear 189. The first synchronizer 166 and the first clutch assembly 172 are controlled by the controller 128 to allow the first high speed reduction gear 189 to drive the first output member 162, the first output member 162 to drive the first output shaft gear 192, and the first output shaft gear 192 to drive a final drive gear 194 which drives the transmission output 118 as would be known by an ordinary person skilled in the art now or in the future.

The fifth gearset 116 includes an output auxiliary speed gear 187, an auxiliary output gear 177, a first output member 162, the third synchronizer 170, the first clutch assembly 172, and the first output shaft gear 192. When the fifth gearset 116 drives the transmission output 118, the transmission 106 may be in an auxiliary gear 314 (described in relation to FIG. 3) to drive the vehicle. When the fifth gearset 116 is driving the transmission output 118, output auxiliary speed gear 187 engages the auxiliary output gear 177. The third synchronizer 170 and the first clutch assembly 172 are controlled by the controller 128 to allow the auxiliary output gear 177 to drive the first output member 162, the first output member 162 to drive the first output shaft gear 192, and the first output shaft gear 192 to drive a final drive gear 194 which drives the transmission output 118 as would be known by an ordinary person skilled in the art now or in the future.

The function and position of the synchronizers 166, 168, 170 and clutch assemblies 172, 174 when the transmission 106 is shifting in the depicted embodiment are described in more detail in U.S. Pat. No. 7,530,913 B2 and would be well known by an ordinary person skilled in the art.

In the depicted embodiment, the transmission 106 includes a variator output speed sensor 134 and a transmission output speed sensor 136. The variator output speed sensor 134 is configured to generate a signal indicative of the output speed of the variator 120 at the variator output gear 158. The transmission output speed sensor 136 is configured to generate a signal indicative of the output speed of the transmission 106 at transmission output 118.

The operator interface 142 may include devices with which a vehicle or machine operator communicates with, interacts with, or controls the vehicle or machine. In one embodiment. the operator interface 142 may include devices with which the operator interacts physically. In another embodiment, the devices may operate with voice activation. In still other embodiments, the operator may interact with the operator interface 142 in any way an ordinary person skilled in the art would contemplate now or in the future.

In the embodiment depicted, the operator interface 142 includes a torque pedal 144. The operator may depress the torque pedal 144 to indicate a desired vehicle or machine output torque. The desired output torque may be applied to ground engaging devices such as wheels or tracks. In other embodiments the desired toque may be a machine shaft, or on a marine vehicle, a propeller. In the depicted embodiment, the torque pedal 144 and/or devices and sensors connected to the torque pedal 144 are configured to generate a desired torque signal indicative of the desired torque at the transmission output 118 as indicated by the operator.

In other embodiments, the operator may indicate desired torque through (an)other input device(s) included in the operator interface 142. The input device(s) may include but is/are not limited to pedals, levers, switches, buttons, keyboards, interactive displays, dials, remote control devices, voice activated controls, and/or any other operator input devices that an ordinary person skilled in the art would understand to be functional in the disclosed embodiments now or in the future.

The controller 128 may include a processor 132 and a memory component 130. The processor 132 may be a microprocessor or other processor as known in the art.

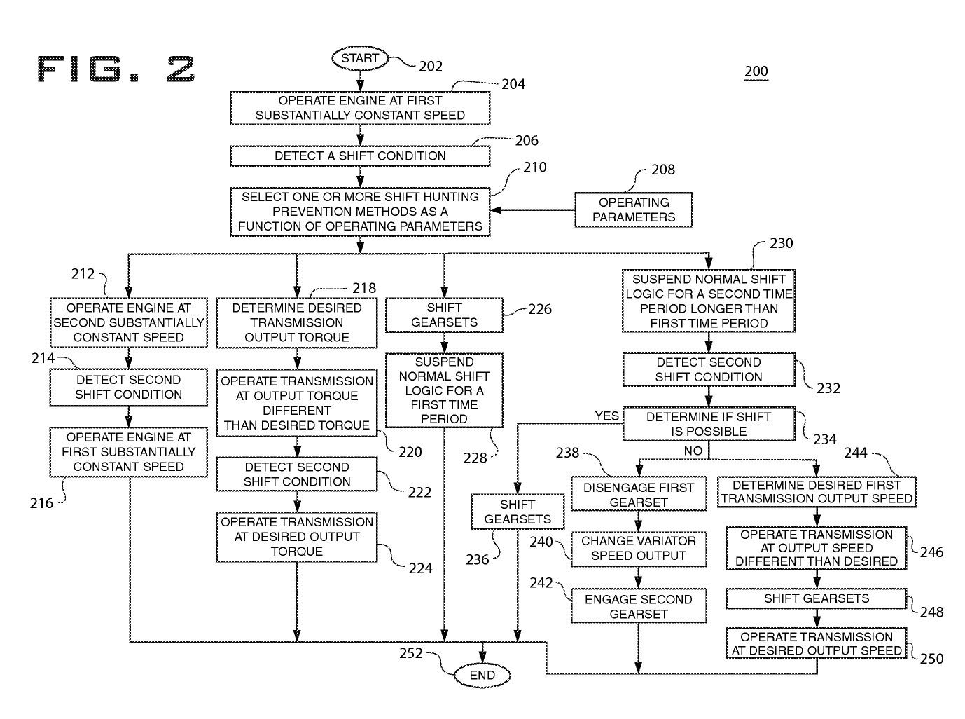

The processor 132 may execute instructions to prevent shift hunting in powertrain 102 as described below in connection with FIGS. 2-5.

Such instructions may be read into or incorporated into a computer readable medium, such as the memory component 130 or provided external to processor 132. In alternative embodiments, hard-wired circuitry may be used in place of or in combination with software instructions to implement a method of preventing shift hunting in the powertrain 102. Thus embodiments are not limited to any specific combination of hardware circuitry and software.

The term “computer-readable medium” as used herein refers to any medium or combination of media that participates in providing instructions to processor for execution. Such a medium may take many forms, including but not limited to, non-volatile media, volatile media, and transmission media. Non-volatile media includes, for example, optical or magnetic disks. Volatile media includes dynamic memory. Transmission media includes coaxial cables, copper wire and fiber optics, and may in some embodiments take the form of transmitters and receivers of acoustic or light waves, such as those generated during radio-wave and infra-red data.

Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, and EPROM, a FLASH-EPROM, any other memory chip or cartridge, or any other medium from which a computer or processor 132 can read which would be known by an ordinary person skilled in the art now or in the future.

The memory component 130 may include any form or combination of forms of computer-readable media as described above. The memory component 130 and processor 132 may be located on the vehicle or machine including the powertrain 102. In an alternative embodiment, the memory component 130 and/or the processor 132 may be located remotely from the vehicle or machine. In still another alternative embodiment, the memory component 130 may include several types of computer readable media some located on-board the vehicle or machine and some located remotely.

The processor 132 and the memory component 130 may be contained in one or more units. The controller 128 is not limited to electronic and electrical circuitry and software. In other embodiments the controller 128 may include hydraulic circuits, pneumatic circuits, mechanical control devices, or a combination of these and electronic and electrical circuitry and software may implement a control method.

The controller 128 is communicatively connected to the engine 104 to receive signals indicative of engine 104 speed and to transmit to the engine 104 control command signals through communication link 138. Engine speed sensing and electronic engine control, including electronic engine speed control, are well known by ordinary persons skilled in the art.

The controller 128 is communicatively connected to the variator 120 to control the speed and torque output of the variator 120 through communication link 138. Speed and torque control of variators 120 is well known by ordinary persons skilled in the art.

The controller 128 is communicatively connected to the variator output speed sensor 134 to receive signals indicative of the variator 120 output speed at variator output gear 158 through communication link 138.

The controller 128 is communicatively connected to the operator interface 142 to receive signals indicative of operator commands through communication link 138 as would be known by ordinary persons skilled in the art now or in the future. In the depicted embodiment, these signals include signals indicative of operator desired torque as indicated by the position of the torque pedal 144.

The controller 128 is communicatively connected to the transmission output speed sensor 136 to receive signals indicative of the transmission output speed at transmission output 118 through communication link 138.

The controller 128 is communicatively connected to the synchronizers 166, 168, 170 to control the gear shifting of transmission 106 through communication link 138. Gear shifting through control of synchronizers is well known by ordinary persons skilled in the art.

The controller 128 is communicatively connected to the clutch assemblies 172, 174 to control the gear shifting of transmission 106 through communication link 138. Gear shifting through control of clutch assemblies is well known by ordinary persons skilled in the art.

### Industrial Applicability

Referring now to FIG. 2, a flow chart of an exemplary method to prevent shift hunting 200 in a powertrain 102 is depicted. The powertrain 102 includes the engine 104 and the transmission 106. The transmission 106 includes a variator 120, a first gearset 108, and a second gearset 110. The method 200 starts at step 202.

The method 200 includes operating the engine 104 at a first substantially constant speed 204, detecting a first transmission 106 shift condition 206, selecting, as a function of operating parameters 208, one or more shift hunting prevention methods 210, and implementing the one or more selected shift hunting prevention methods as a function of detecting the first transmission 106 shift condition.

Internal combustion and other fuel burning engines 104 are subject to increasing emission controls in many geographic areas. Frequently, meeting the emission controls results in reduced fuel economy and, consequently, higher costs in operating vehicles and machines. Operating an engine 104 at a substantially constant speed may increase fuel economy while still meeting emission requirements.

For purposes of this application, operating an engine 104 at a substantially constant speed means governing the engine 104, or controlling the output rotational speed of the engine 104 to a value within the tolerances of the engine 104 and the system 100 it is powering. For example, an engine 104 may be governed to 1000 rpm. Because of tolerance in the speed sensing system, control system, and engine 104 parts in manufacturing, there may be slight differences in actual engine 104 speed to the desired engine 104 speed. When loads are connected or disconnected from the engine 104, engine speed 104 may increase or decrease for a short time until engine 104 systems can reach a steady state at the desired speed. For example, fuel systems may need to provide more or less fuel and air systems more or less oxygen. Ordinary persons skilled in the art will recognize that when an engine 104 is governed to a constant value, it operates in a narrow speed band, or a substantially constant speed.

In step 204, the engine 104 is operated at a first substantially constant speed as would be known by an ordinary person skilled in the art now or in the future.

Referring now to FIG. 3, an exemplary graph of a relationship 300 between a motor ratio 302 and a transmission ratio 304 is depicted. The “x” or horizontal axis is representative the transmission ratio 304. The “y” or vertical axis is representative of the motor ratio 302.

The transmission ratio 304 is the transmission output 118 speed divided by the input speed to the transmission 106. In the embodiment depicted in FIG. 1, the input speed is the engine 104 speed transmitted through input member 150. The engine 104 includes sensors, devices, and systems to measure or estimate engine 104 speed and communicate engine 104 speed to the controller 128 through communication link 138, as would be known by an ordinary person skilled in the art now or in the future. The transmission output speed sensor 136 is configured to generate a signal indicative of transmission output 118 speed which is communicated to the controller 128 through communication link 138. The controller 128 may calculate transmission ratio 304 as a function of the engine 104 speed signal and the transmission output 118 speed signal.

The motor ratio 302 is the output speed of the variator 120 divided by the input speed to the variator 120. In the embodiment depicted in FIG. 1, the input speed is the engine speed transmitted through input member 150. The output speed is the speed at the variator output gear 158. Variator output speed sensor 134 is configured to generate a signal indicative of variator 120 output speed which is communicated to the controller 128 through communication link 138 as would be known by an ordinary person skilled in the art now or in the future. The controller 128 may calculate the motor ratio 302 as a function of the engine speed signal and the variator 120 output speed signal.

When the engine 104 is operated at a substantially constant speed, an ordinary person skilled in the art will realize that the relationship 300 between the motor ratio 302 and the transmission ratio 304 is substantially equal to the relationship between the output speed of the variator 120 and the transmission output 118 speed.

Low forward gear line 306 represents the relationship 300 between the motor ratio 302 and the transmission ratio 304 when transmission output 118 is driven by the first gearset 108, and the engine 104 is operated at a substantially constant speed.

High forward gear line 308 represents the relationship 300 between the motor ratio 302 and the transmission ratio 304 when transmission output 118 is driven by the second gearset 110, and the engine 104 is operated at a substantially constant speed.

Low reverse gear line 310 represents the relationship 300 between the motor ratio 302 and the transmission ratio 304 when transmission output 118 is driven by the third gearset 112, and the engine 104 is operated at a substantially constant speed.

High reverse gear line 312 represents the relationship 300 between the motor ratio 302 and the transmission ratio 304 when transmission output 118 is driven by the fourth gearset 114, and the engine 104 is operated at a substantially constant speed.

Auxiliary gear line 314 represents the relationship 300 between the motor ratio 302 and the transmission ratio 304 when transmission output 118 is driven by the fifth gearset 116, and the engine 104 is operated at a substantially constant speed.

Shifts between two gearsets 108, 110, 112, 114, 116 may be done smoothly and quickly when the motor ratios 302 and transmission ratios 304 are equal for both gearsets 108, 110, 112, 114, 116. At these points, the variator 120 output speed and the transmission output 118 speed is equal. In the embodiments represented in FIGS. 1 and 3, ideal shift points occur between low forward 306 and high forward 308 at point 316, between low forward 306 and low reverse 310 at point 338, and between low reverse 310 and high reverse 312 at point 340.

Because there is no point on high forward gear 308 and auxiliary gear 314 where the motor ratio 302 and the transmission ratio 304 are equal, an upshift between these two gearsets 110, 116 may be accomplished through disengaging the second gearset 110 from driving transmission output 118 at point 336, changing the variator 120 output speed, and engaging the fifth gearset 116 at point 334. A downshift may be accomplished by disengaging the fifth gearset 116 from driving transmission output 118 at point 334, changing the variator 120 output speed, and engaging the second gearset 110 at point 336.

In some conditions a vehicle or machine may operate in a band around a shift point for a period of time. For example, when a vehicle is driving on a road with numerous hills the transmission 106 may sometimes operate on either side of a shift point continuously. This may create a condition known as shift hunting where a transmission 106 shifts rapidly from one gear to another and then back again. This may be characterized as macro-shift hunting and is well known by ordinary persons skilled in the art. This condition may be annoying to the operator and may result in decreased fuel economy.

Another type of shift hunting may occur when the vehicle or machine begins to operate at a steady speed or operating condition at or in a narrow band around a shift point. The controller 128 shifts the transmission 106 back and forth very quickly between two gearsets 108, 110, 112, 114, 116 in response to the condition. This type of shift hunting may be happening in very minute time periods, such as micro-seconds, and may be referred to as micro-shift hunting.

In transmissions including flexible or fluid couplings, the shift point is often delayed when a shift hunting condition is detected such that a vehicle or machine will operate on one side of the shift point and using one gearset 108, 110, 112, 114, 116 continuously. If the vehicle or machine must shift, the flexible or fluid coupling may absorb any mechanical shock in the powertrain 102 due to different gear speeds at the delayed shift point. Delaying shift points to prevent shift hunting is well known to ordinary persons skilled in the art.

In a system without flexible couplings, such as the system 100 depicted in FIG. 1, undue stress on the powertrain 102, operator discomfort, and/or transmission 106 damage or wear may occur by shifting gearsets 108, 110, 112, 114, 116 at a delayed shift point. For example, if the controller 128 delayed shift point 316 to shift point 318 to prevent shift hunting, the transmission 106 may be subject to shocks causing damage and operator discomfort. Ideally, the transmission 106 would shift from point 318 to a point to the right of the shift point 316 in high forward gear 308 to maintain the same transmission ratio 304. But, the variator 120 may not be able to increase or decrease speed instantaneously and the mechanical limitations of transmission 106 will not allow this to happen. Instead stresses in many portions of the powertrain 102 will result. This may cause the powertrain to operate at various points of the relationship 300 and the transmission 106 may suffer damage or severe wear. For example, the transmission may shift instead to point 320. A jerk will be felt, as the transmission output 118 speed is reduced through mechanical limitations. The controller 128 may sense that at point 320, the variator 120 and vehicle or machine speed is such that a shift back to low forward 306 is necessary. The transmission 106 then shifts to low forward 306 with another jerk. This may continue until the system stabilizes.

Although the embodiment depicted in FIG. 1 does not include flexible couplings, and the shift hunting prevention method 200 is described in relation to a system 100 without flexible couplings, the method 200 may be applicable to systems without flexible couplings as would be known by an ordinary person skilled in the art now or in the future.

Referring back to FIG. 2, the controller 128 may detect a transmission 106 shift condition at step 206. The transmission 106 shift condition may include sensing that the powertrain 102 is operating in a manner that a shift is imminent, and/or detecting a shift hunting condition. For example, as the transmission output 118 speed approaches a shift point in one gearset 108, 110, 112, 114, 116, the controller 128 may sense that a shift is imminent. Predicting imminent shifts in transmissions is well known by ordinary persons skilled in the art. Detecting shift hunting conditions is also well known by ordinary persons skilled in the art.

In step 210, the controller 128 may select one or more shift hunting prevention methods as a function of operating parameters 208. In the depicted embodiment, the group of shift hunting prevention methods includes a first shift hunting prevention method, a second shift hunting prevention method, a third shift hunting prevention method, a fourth shift hunting prevention method, and a fifth shift hunting prevention method. In other embodiments the group may include a different number of shift hunting prevention methods. The group may also include shift hunting prevention methods not depicted, which would be known by an ordinary person skilled in the art now or in the future.

The first shift hunting prevention method may include steps 212, 214, and 216. The second shift hunting prevention method may include steps 218, 220, 222, and 224. The third shift hunting prevention method may include steps 226, and 228. The fourth shift hunting prevention method may include steps 230, 232, 234, 238, 240, and 242. The fifth shift hunting prevention method may include steps 230, 232, 234, 244, 246, 248, and 250.

### State Machine

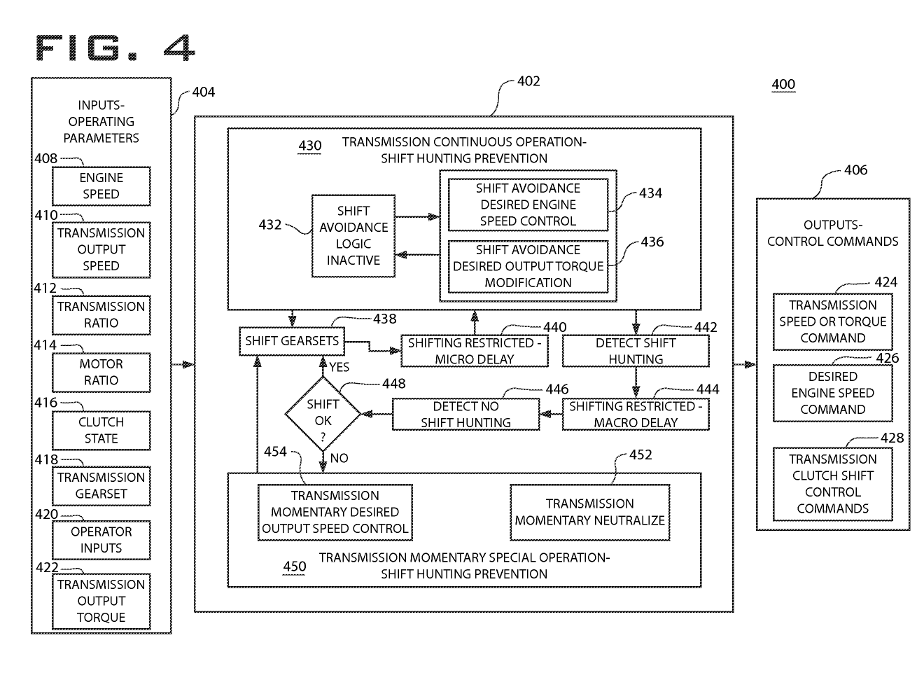

Referring now to FIG. 4, the one or more shift hunting prevention methods may be selected using a state machine 400. The state machine 400 may be developed using model based development based on experimental data. The state machine 400 may have operating parameters 208 as inputs 404 and control commands to implement the one or more selected methods as outputs 406.

In another embodiment, an operating parameter look-up table, or a map developed through experimental use of a powertrain 102 or modeling of powertrain 102 may be used to select one or more shift hunting prevention method. In another embodiment the selection of one or more shift hunting prevention methods may be accomplished through algorithms using one or more operating parameters 208. In another embodiment a combination of state machines, tables, and/or algorithms may be used to select one or more shift hunting prevention methods. The one or more shift hunting prevention methods may be selected as a function of operating parameters 208 in any way that would be known by an ordinary person skilled in the art now or in the future.

Operating parameters 208 may include any operating parameter an ordinary person skilled in the art now or in the future would consider when selecting one or more shift hunting prevention methods from a group of shift hunting prevention methods. Non-limiting examples include engine speed 408, transmission output speed 410, transmission ratio 412, motor ratio 414, transmission clutch shift control information 416, which gearset is engaged 418, operator inputs 420, and transmission output torque 422. Operator inputs 420 may include but are not limited to pedal 144 position and gear range selector (not shown) position.

Logic 402 to select one or more shift hunting prevention methods may be implemented by the controller 128. Block 430 may represent the shift hunting prevention method logic active during continuous operation. This logic may be the default logic.

The continuous logic 430 may include state 432 where shift avoidance logic is inactive. Experimental data, other reasoning, or other logic may indicate that under some operating conditions there is little or no risk of shift hunting in the transmission 106, and thus no need for any control logic to prevent shift hunting.

The first transmission 106 shift condition may include an impending shift. The controller 128 may determine that a shift is impending if the transmission ratio 304 is in a predetermined range. That predetermined range may be an operating band around a shift point. When the controller 128 detects an impending shift, the controller 128 may control the powertrain 102 in accordance to shift avoidance logic corresponding to states 434 and/or 436. The first shift hunting prevention method may correspond to state 434. The second shift hunting prevention method may correspond to state 436.

The first shift hunting prevention method and/or the second shift hunting prevention method may act to prevent a shift of gearsets 108, 110, 112, 114, 116 from occurring for such that the vehicle or stationary machine operates with one gearset 108, 110, 112, 114, 116 engaged.

The controller 128 may detect a second transmission 106 shift condition. The second transmission 106 shift condition may include operating conditions where the transmission ratio 304 has changed to within a range where a shift is no longer impending. When the controller 128 detects that there is no longer an impending shift, the state may change back to state 432 where no shift hunting prevention methods are active.

In other operating conditions, the second transmission 106 shift condition may include shifting gearsets 438. An operator may indicate through the torque pedal 144 or other device on the operator interface 142 that he/she desire to continue to increase or decrease torque. Even with the first and second shift hunting prevention methods active, the transmission ratio may continue to increase or decrease such that shifting gearsets 438 is necessary. The controller 128 may communicate commands to the powertrain 102 to shift gearsets 438.

When the powertrain 102 shifts gearsets 438, the controller 128 may suspend otherwise active shift logic for a first time period to prevent micro shift hunting. The first time period may be short enough that the operator may not notice this short suspension of shift logic. For example, the first time period may be less than one hundred (100) microseconds. State 440 represents this suspension of otherwise active shift logic and may correspond to the third shift hunting prevention method.

After the first time period, the state machine 400 may move back to the continuous logic block 430.

The first transmission 106 shift condition may include detecting a shift hunting condition 442. When the controller 128 detects a shift hunting condition 442, the state machine 400 may move to state 444. State 444 may correspond to a step in the fourth shift hunting prevention method and/or the fifth shift hunting prevention method. In state 444, otherwise active shift logic may be suspended for a second period of time, or until a second transmission 106 shift condition is detected. The second period of time may be longer than the first period of time. The second transmission 106 shift condition may include detecting an anti-shift hunting condition 446.

After restricting otherwise active shift logic for the second period of time, the transmission ratio 304 may have changed to where a synchronous shift is no longer possible. The controller 128 may determine whether a synchronous shift is still possible 448 after the second time period.

If a synchronous shift is possible after the second time period, then the logic in the state machine 400 may move back to shifting gearsets 438.

If a synchronous shift is not possible, the state machine 400 may move to logic contained in block 450. In the depicted embodiment, block 450 includes logic to implement the fourth shift hunting prevention method in block 452 and the fifth shift hunting prevention method in block 454. The controller 128 may implement logic in block 450 and then shift gearsets 108, 110, 112, 114, 116, in accordance to the fourth shift hunting prevention method or the fifth shift hunting prevention method.

### First Shift Hunting Prevention Method

Referring back to FIG. 2, the first shift hunting prevention method may include steps 212, 214, 216, and 252. In step 212, the controller 128 operates the engine 104 at a second substantially constant speed, different than the first speed. In one embodiment the second substantially constant speed is within three hundred (300) revolutions per minute (RPM) of the first substantially constant speed.

Referring again to FIG. 3, while the transmission 106 is operating at the first substantially constant speed in low forward gear 306, it may approach the shift point 316 between low forward gear 306 and high forward gear 308. It may be desirable for the transmission 106 to operate constantly in either low forwards gear 306 or high forward gear 308, rather than shift back and forth between the two gearsets 108, 110.

A first transmission 106 shift condition may be detected. The first transmission 106 shift condition may be detected when the transmission 106 reaches a point 322 within a predetermined value of the transmission ratio 304 at the shift point 316. When the transmission reaches point 322 the controller 128 may operate the engine 104 at a second substantially constant speed. The second substantially constant speed may be greater than the first substantially constant speed. Increasing the engine 104 speed may tend to move the point of transmission 106 operation away from the shiftpoint 316. For example, increasing the engine 104 speed may move the point of operation from point 322 to point 324 while maintaining the same transmission output 118 speed, or vehicle speed in a vehicle embodiment. Operating the engine 104 at the second substantially constant speed may allow the transmission 106 to operate continuously in low forward gear 306.

Referring back to FIG. 2, in step 214, the controller 128 may detect a second transmission 106 shift condition. The second transmission 106 shift condition may include a shift between two gearsets 108, 110, 112, 114, 116. The operator of a vehicle or machine including a powertrain 102 may wish to continue to accelerate transmission output 118 speed, causing a shift at shiftpoint 316.

In an alternative embodiment, the vehicle or machine transmission output 118 may decrease after the engine 104 speed is changed from the first substantially constant speed to the second substantially constant speed. As the transmission output 118 speed continues to decrease, the transmission ratio 304 may reach a value where the risk of shift hunting is minimal. In this embodiment, the second transmission 106 shift condition may include the transmission ratio being less than or equal to a predetermined value.

In an embodiment where the first transmission 106 shift condition includes a shift hunting condition, the second transmission 106 shift condition may include an anti-shift hunting condition. If the powertrain 102 is operating in a small band around shiftpoint 316, a shift hunting condition may occur. Operating the engine 104 at a second substantially constant speed may move the operating point away from the shiftpoint 316, resulting in an anti-shift hunting condition.

In other embodiments, the second transmission 106 shift condition may include any condition that would indicate that the risk of a shift hunting condition has decreased and that it is desirable to operate the engine 104 at the first substantially constant speed that would be known to an ordinary person skilled in the art now or in the future.

Referring back to FIG. 2, in step 216, the controller 128 may operate the engine 104 at the first substantially constant speed as a function of detecting the second transmission 106 shift condition. If the transmission 106 shifts from low forward gear 306 to high forward gear 308, it may be desirable that the transmission 106 operating point move as far from the shiftpoint 316 as possible to prevent a shift hunting condition.

Referring to FIG. 3, in a non-limiting example, after shifting from low forward gear 306 to high forward gear 308, the transmission 106 may be operating at point 326. The engine 104 may be operating at the second substantially constant speed. The controller 128 may operate the engine at the first substantially constant speed, moving the operating point away from the shiftpoint 316 to point 328, without impacting transmission output 118 speed. At this operating point there may be less risk of shift hunting.

In another example, where the transmission output speed 118 decreased after the engine speed 102 changed to the second substantially constant speed, and the second transmission 106 shift condition included the transmission ratio 104 being less than or equal to a predetermined value, the controller may change the engine 104 speed to the first substantially constant speed as a function of detecting the second transmission 106 shift condition. In a non-limiting example, the controller 128 may detect the second transmission 106 shift condition when the transmission ratio 104 is at point 330. The controller 128 may operate the engine 104 at the first substantially constant speed as a function of detecting the second transmission 106 shift condition. The transmission 106 operating point may move from point 330 to point 322 when the engine 104 speed changes from the second substantially constant speed to the first substantially constant speed, without changing the transmission output 118 speed.

Although the depicted embodiment of the first shift hunting prevention method is described in relation to an upshift of gears, an ordinary person skilled in the art will understand that the same method is applicable in downshifts as well. Although the depicted embodiment of the first shift hunting prevention method has been described in relation to a shift between low forward 306 and high forward 308, an ordinary person skilled in the art will understand that the same method applied to shifts between low forward 306 and low reverse 310; and low reverse 310 and high reverse 312.

Although the shift from high forward gear 308 to auxiliary gear 314, and from auxiliary gear 314 to high forward gear 308 requires neutralizing the transmission, the depicted embodiment of the first shift hunting prevention method may still be applicable. While changing variator 120 speed, engine 104 speed may also change from a first substantially constant speed to a second substantially constant speed to reduce the time needed for the shift. Once the shift is accomplished, the engine 104 may again operate at the first substantially constant speed.

### Second Shift Hunting Prevention Method

Referring back to FIG. 2, the second shift hunting prevention method may include steps 218, 220, 222, 224, and 252. In step 218, the controller 128 may determine a desired torque. In the embodiment depicted in FIG. 1, the desired torque may be indicated by the operator though the position of the torque pedal 144 or another device included in the operator interface 142. In other embodiments the desired torque may be a calculated value. The desired torque may be determined by any means that would be known by an ordinary person skilled in the art now or in the future.

In step 220, the controller 128 may operate the transmission at a transmission output torque different than the desired transmission output torque. In some embodiments, the output torque which the controller 128 operates the transmission 106 at, in step 220, may be slightly different than the desired output torque. In these embodiments the operator of a vehicle or stationary machine including the powertrain 102 may not be able to detect the difference.

Referring again to FIG. 3, while the transmission 106 is operating at the first substantially constant speed in low forward gear 306, it may approach the shift point 316 between low forward gear 306 and high forward gear 308. It may be desirable for the transmission 106 to operate constantly in either low forwards gear 306 or high forward gear 308, rather than shift back and forth between the two gearsets 108, 110.

A first transmission 106 shift condition may be detected. The first transmission 106 shift condition may be detected when the transmission 106 reaches a point 322 within a predetermined value of the transmission ratio 304 at the shift point 316. When the transmission reaches point 322 the controller 128 may operate the transmission at an output torque different than the desired torque. This different output torque may be slightly less than the desired output torque. Operating the transmission 106 at an output torque slightly less than the desired output torque may allow the transmission 106 to operate continuously in low forward gear 306.

Referring back to FIG. 2, in step 222, the controller 128 may detect a second transmission 106 shift condition. The second transmission 106 shift condition may include a shift between two gearsets 108, 110, 112, 114, 116. The operator of a vehicle or machine including a powertrain 102 may wish to continue to accelerate transmission output 118 speed, causing a shift at shiftpoint 316.

In an alternative embodiment, the vehicle or machine transmission output 118 may decrease after the transmission 106 output torque is changed to an output torque different than the desired transmission output torque. As the transmission output 118 speed continues to decrease, the transmission ratio 304 may reach a value where the risk of shift hunting is minimal. In this embodiment, the second transmission 106 shift condition may include the transmission ratio being less than or equal to a predetermined value.

In an embodiment where the first transmission 106 shift condition includes a shift hunting condition, the second transmission 106 shift condition may include an anti-shift hunting condition. If the powertrain 102 is operating in a small band around shiftpoint 316, a shift hunting condition may occur. Operating the transmission 106 at an output torque different than the desired torque may move the operating point away from the shiftpoint 316, resulting in an anti-shift hunting condition.

In other embodiments, the second transmission 106 shift condition may include any condition that would indicate that the risk of a shift hunting condition has decreased and that it is desirable to operate the transmission 106 at the desired output torque that would be known to an ordinary person skilled in the art now or in the future.

Referring back to FIG. 2, in step 224, the controller 128 may operate the transmission 106 at the desired torque as a function of detecting the second transmission 106 shift condition. If the transmission 106 shifts from low forward gear 306 to high forward gear 308, it may be desirable that the transmission 106 operating point move as far from the shiftpoint 316 as possible to prevent a shift hunting condition.

Referring to FIG. 3, in a non-limiting example, after shifting from low forward gear 306 to high forward gear 308, the transmission 106 may be operating at point 326. The transmission 106 may be operating at an output torque slightly below the desired output torque. The controller 128 may operate the transmission 106 at the desired output torque, moving the operating point away from the shiftpoint 316 to point 328. At this operating point there may be less risk of shift hunting.

In another example, where the transmission output speed 118 decreased after the transmission 106 was operated at an output torque different than the desired torque, and the second transmission 106 shift condition included the transmission ratio 104 being less than or equal to a predetermined value, the controller may operate the transmission 106 at the desired output torque as a function of detecting the second transmission 106 shift condition. In an example, the controller 128 may detect the second transmission 106 shift condition when the transmission ratio 104 is at point 330. The controller 128 may operate the transmission 106 at the desired output torque as a function of detecting the second transmission 106 shift condition.

Although the depicted embodiment of the second shift hunting prevention method is described in relation to an upshift of gears, an ordinary person skilled in the art will understand that the same method is applicable in downshifts as well. Although the depicted embodiment of the second shift hunting prevention method has been described in relation to a shift between low forward 306 and high forward 308, an ordinary person skilled in the art will understand that the same method applied to shifts between low forward 306 and low reverse 310; and low reverse 310 and high reverse 312.

Although the shift from high forward gear 308 to auxiliary gear 314, and from auxiliary gear 314 to high forward gear 308 requires neutralizing the transmission, depicted embodiment of the first shift hunting prevention method may still be applicable. While changing variator 120 speed, the transmission 106 may be operated at an output torque different than the desired output torque to reduce the time needed for the shift. Once the shift is accomplished, the transmission 106 may be operated at the desired output torque.

### Third Shift Hunting Prevention Method

Referring back to FIG. 2, the third shift hunting prevention method may include steps 226, 228, and 252. In step 226 the controller 128 may generate commands to cause the transmission 106 to shift gearsets 108, 110, 112, 114, 116. In some operating conditions, the transmission 106 may be operating right at or very close to the shiftpoint. Due to these operating conditions and/or other factors, a condition of micro shift hunting may occur in the transmission 106.

In step 228, either as a result of detecting micro shift hunting, or as a preventive measure, the controller 128 may suspend otherwise active shift logic for a first period of time. The first time period may be short enough that the operator of the vehicle or stationary machine may not detect any time delay in the shift. In some embodiments, the first time period may be in the range of equal to or greater than 50 micro-seconds, and less than or equal to 150 micro-seconds.

In some embodiments, the third shift hunting prevention method may be implemented after every shift. In some embodiments the third shift hunting method may be implemented along with other shift hunting prevention methods.

### Fourth Shift Hunting Prevention Method

The fourth shift hunting method may include steps 230, 232, 234, 238, 240, 242, and 252. In step 230 the controller 128 may suspend otherwise active shift logic for a second period of time as a function of detecting a first shift condition. The second period of time may be greater than the first period time. The first shift may be a shift hunting condition.

If a shift hunting condition in the transmission 106 is detected, suspending otherwise active shift logic for a period of time may stop any shifting of gearsets 108, 110, 112, 114, 116 from occurring, thus preventing any further shift hunting.

In step 232 the controller 128 may detect a second shift condition. The second shift condition may include an anti-shift hunting condition. For example, the relationship between the transmission ratio 306 and the motor ratio 302 may have changed such that there is little risk of a shift hunting condition occurring.

During the second period the relation between the transmission ratio 304 and the motor ratio 302 may move far enough from a shift point that a synchronous shift is not possible. For the purpose of this application a synchronous shift is not possible when shifting of gearshifts would cause greater wear or damage to the powertrain 102 due to mechanical shocks, or cause greater discomfort to the operator than would be acceptable. What is acceptable may vary based on the materials and components included in the powertrain 102, and the operators or industries the machine or vehicle containing the powertrain 102 is targeted for. What is acceptable can vary between a shift where the relationships between the transmission ratio 304 and the motor ratio 306 are equal in the two gears being shifted between, to where a shift will cause unacceptable damage or wear to powertrain 102 components. This range may be determined by experimental data or through modeling and analysis. The range of a synchronous shift may be defined in the controller 128 as the relationship between the transmission ratio 304 and the motor ratio 302 in the two gears being shifted between being less than or less than or equal to a predetermined value. Determining the range of an acceptable synchronous shift is known by ordinary persons in the art.

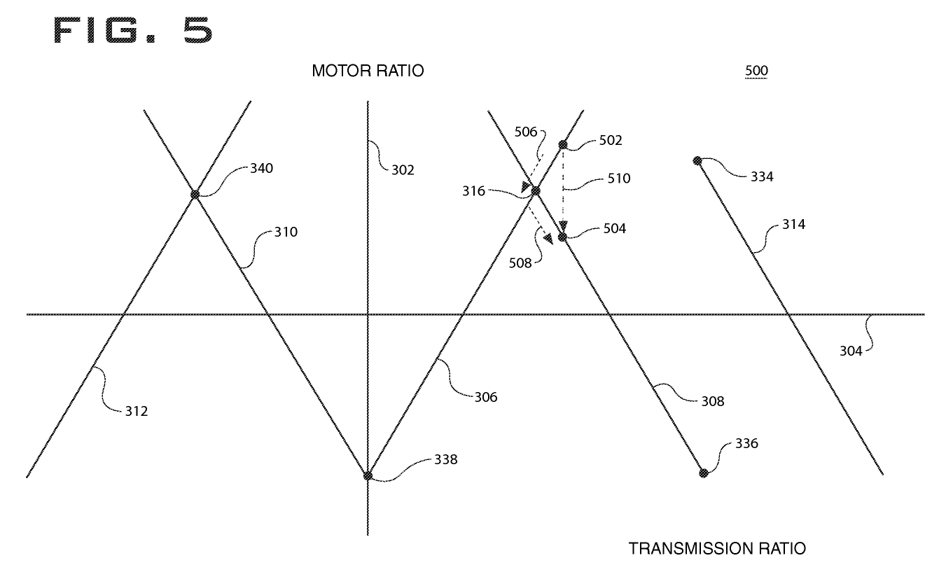

Referring now to FIG. 5, an exemplary graph of a relationship 500 between a motor ratio 302 and a transmission ratio 304 is depicted. The relationship is the same as the relationship in FIG. 3 and like numerals are used to refer to like elements. In a non-limiting example, a shift hunting condition may have occurred between low forward gear 306 and high forward gear 308. The controller 128 may have suspended otherwise active shift logic such that the transmission 106 may operate at point 502. At point 502, a synchronous shift between low forward gear 306 and high forward gear 308 to point 504 may not be possible.

Referring back to FIG. 2, in step 234, the controller 128 may determine if a synchronous shift is possible. The controller 128 may compare the relationship between the transmission ratio 304 and the motor ratio 302 in the gear the transmission 106 is currently operating in, and the gear that it is desired to shift into. For example, in relation to FIG. 5, the controller 128 may compare the relationship of the transmission ratio 304 and the motor ratio 302 at operating point 502 on low forward gear with the relationship of the transmission ratio 304 and the motor ratio 302 at operating point 504 on high forward gear. The controller 128 may determine if the difference is less than a predetermined value. If the difference is less than the predetermined value, the controller 128 may determine that a synchronous shift is possible. If the difference is equal to or greater than the predetermined value the controller 128 may determine that a synchronous shift is not possible. In other embodiments, the controller 128 may determine if a synchronous shift is possible in any way that would be known to an ordinary person skilled in the art now or in the future.

If the controller 128 determines that a shift is possible in step 234, the method may proceed to step 236 where the controller 128 controls the transmission 106 to shift gearsets 108, 110, 112, 114, 116.

If the controller 128 determines that a shift is not possible the method may proceed to step 238.

In step 238, the controller 128 may control the transmission 106 to disengage the first gearset 108.

In step 240, the controller 128 may control the variator 120 to change output speed such that the variator is at the speed necessary for a synchronous shift into a second gearset 110.

In step 242, the controller may control the transmission 106 to engage the second gearset 110.

In an example exemplified in FIG. 5, when otherwise active shift logic is suspended, the transmission 106 may operate at point 502. The controller 128 may detect an anti-shift hunting condition and determine that a synchronous shift to high forward gear 308 is not possible. The controller 128 may control the transmission 106 to disengage the first gearset 108. The controller 128 may then control the variator 120 to decrease speed until the variator 120 is operating to produce a motor ratio 302 within a predetermined value of operating point 504. This is depicted with dotted line 510. The controller may then control the transmission 106 to engage the second gearset 110.

Although the depicted embodiment of the fourth shift hunting prevention method is described in relation to an upshift of gears, an ordinary person skilled in the art will understand that the same method is applicable in downshifts as well. Although the depicted embodiment of the fourth shift hunting prevention method has been described in relation to a shift between low forward 306 and high forward 308, an ordinary person skilled in the art will understand that the same method applied to shifts between low forward 306 and low reverse 310; and low reverse 310 and high reverse 312.

### Fifth Shift Hunting Prevention Method

The fifth shift hunting method may include steps 230, 232, 234, 244, 246, 248, 250, and 252. In step 230 the controller 128 may suspend otherwise active shift logic for a second period of time as a function of detecting a first shift condition. The second period of time may be greater than the first period time. The first shift may be a shift hunting condition.

If a shift hunting condition in the transmission 106 is detected, suspending otherwise active shift logic for a period of time may stop any shifting of gearsets 108, 110, 112, 114, 116 from occurring, thus preventing any further shift hunting.

In step 232 the controller 128 may detect a second shift condition. The second shift condition may include an anti-shift hunting condition. For example, the relationship between the transmission ratio 306 and the motor ratio 302 may have changed such that there is little risk of a shift hunting condition occurring.

During the second period the relation between the transmission ratio 304 and the motor ratio 302 may move far enough from a shift point that a synchronous shift is not possible.

Referring now to FIG. 5, in a non-limiting example, a shift hunting condition may have occurred between low forward gear 306 and high forward gear 308. The controller 128 may have suspended otherwise active shift logic such that the transmission 106 may operate at point 502. At point 502, a synchronous shift between low forward gear 306 and high forward gear 308 to point 504 may not be possible.

Referring back to FIG. 2, in step 234, the controller 128 may determine if a synchronous shift is possible. The controller 128 may compare the relationship between the transmission ratio 304 and the motor ratio 302 in the gear the transmission 106 is currently operating in, and the gear that it is desired to shift into. For example, in relation to FIG. 5, the controller 128 may compare the relationship of the transmission ratio 304 and the motor ratio 302 at operating point 502 on low forward gear with the relationship of the transmission ratio 304 and the motor ratio 302 at operating point 504 on high forward gear. The controller 128 may determine if the difference is less than a predetermined value. If the difference is less than the predetermined value, the controller 128 may determine that a synchronous shift is possible. If the difference is equal to or greater than the predetermined value the controller 128 may determine that a synchronous shift is not possible. In other embodiments, the controller 128 may determine if a synchronous shift is possible in any way that would be known to an ordinary person skilled in the art now or in the future.

If the controller 128 determines that a shift is possible in step 234, the method may proceed to step 236 where the controller 128 controls the transmission 106 to shift gearsets 108, 110, 112, 114, 116.

If the controller 128 determines that a shift is not possible the method may proceed to step 244. In step 244, the controller 128 may determine a desired transmission output 118 speed. The desired transmission output 118 speed may be determined as a function of an operator input. The operator input may be inputted by an operator through the operator interface 142. The operator input may be the torque pedal 144 position. In another embodiment, the desired transmission output 118 speed may be determined as a function of one or more operating parameters. In another embodiment, the desired transmission output speed 118 may be determined as a function of both an operator input and one or more operating parameters. In other embodiments, the desired transmission output 118 speed may be determined in any manner as a function of any parameters that would be known by an ordinary person skilled in the art now or in the future.

In step 246, the controller 128 may operate the transmission 106 at a transmission output 118 speed different than the desired transmission output 118 speed. For example, the controller 128 may operate the transmission 106 at a transmission output 118 speed slightly lower than the desired transmission output 118 speed when upshifting, or slightly higher than the desired transmission output 118 speed when downshifting. The difference between the transmission output 118 speed the transmission 106 is operated at and the desired transmission output 118 speed may be small enough that an operator of a vehicle or machine including the powertrain 102 may not notice the difference.

In step 248, the controller 128 may operate the transmission 106 to shift gearsets 108, 110, 112, 114, 116.

In step 250, the controller 128 may operate the transmission 106 at the desired transmission output 118 speed.

In an example exemplified in FIG. 5, when otherwise active shift logic is suspended, the transmission 106 may operate at point 502. The controller 128 may detect an anti-shift hunting condition and determine that a synchronous shift to high forward gear 308 is not possible. The controller 128 may determine the desired transmission output 118 speed. The desired transmission output 118 speed may be the transmission output 118 speed necessary to maintain or increase the transmission ratio 304 at points 502 and 504.

The controller 128 may operate the transmission 106 at a transmission output 118 speed different than the desired transmission output 118 speed. The controller 128 may decrease the transmission output 118 speed until the transmission output 118 speed is equal or within a predetermined value of the transmission output 118 speed necessary for the transmission ratio at shiftpoint 316. This decrease in transmission output 118 speed is indicated by dotted line arrow 506.

The controller 128 may then operate the transmission 106 to shift gearsets 108, 110, 112, 114, 116 from low forward gear 306 to high forward gear 308.

The controller 128 may then increase transmission output 118 speed to the desired transmission output speed as depicted by dotted line arrow 508. The decrease and increase of transmission output 118 speed may not be detectable by an operator. An operator may not be able to detect that he/she is not operating at the desired transmission output 118 speed.

Although the depicted embodiment of the first shift hunting prevention method is described in relation to an upshift of gears, an ordinary person skilled in the art will understand that the same method is applicable in downshifts as well. Although the depicted embodiment of the first shift hunting prevention method has been described in relation to a shift between low forward 306 and high forward 308, an ordinary person skilled in the art will understand that the same method applied to shifts between low forward 306 and low reverse 310; and low reverse 310 and high reverse 312.

At step 252, the method ends.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A method for preventing shift hunting in a powertrain including an engine and a transmission having a variator, a first gearset, and a second gearset, comprising:
operating the engine at a substantially constant speed,
detecting a first shift condition,
determining a desired transmission output torque, and
operating the transmission at a transmission output torque different than the desired transmission output torque as a function of detecting the first shift condition.

2. The method of claim 1, wherein the first shift condition includes an impending shift.

3. The method of claim 1, wherein the first shift condition includes a shift hunting condition.

4. The method of claim 1, further comprising detecting a second shift condition.

5. The method of claim 4, wherein the second shift condition includes the completion of a shift.

6. The method of claim 5, further comprising suspending shift logic for a time period.

7. The method of claim 4, wherein the second shift condition includes detecting a transmission ratio at least a predetermined value from a shift point.

8. The method of claim 1, further comprising operating the engine at the desired output torque as a function of detecting the second shift condition.

9. A system for preventing shift hunting, comprising:
a powertrain including,
an engine, and
a transmission operably connected to the engine, the transmission having a variator, a first gearset, a second gearset, and an output, and
a controller configured to operate the engine at a substantially constant speed, detect a first shift condition, determine a desired transmission output torque, and operate the transmission at a transmission output torque different than the desired transmission output torque as a function of detecting the first shift condition.

10. The system of claim 9, wherein the first shift condition includes an impending shift.

11. The system of claim 9, wherein the first shift condition includes a shift hunting condition.

12. The system of claim 9, wherein the controller is configured to detect a second shift condition.

13. The system of claim 9, wherein the second shift condition includes the completion of a shift.

14. The system of claim 13, wherein the controller is configured to suspend shift logic for a time period.

15. The system of claim 9, wherein the second shift condition includes a transmission ratio at least a predetermined value from a shift point.

16. The system of claim 9, wherein the controller is configured to operate the transmission at the desired torque as a function of the second shift condition.

17. The system of claim 9, wherein the variator includes a hydrostatic transmission.

18. The system of claim 9, wherein the variator includes an electric motor.

19. The system of claim 9, wherein:
the transmission includes an adder,
the engine is operably coupled to the variator, and a mechanical gearing in parallel to the variator, and
the variator and the mechanical gearing are operably coupled through the adder.

20. The system of claim 19, wherein the adder includes at least one planetary gearset.
